(19) United States
(12) Patent Application Publication
(10) Pub. No.: US 2011/0050613 A1
(43) Pub. Date: Mar. 3, 2011

(54) METHOD OF USING ELECTRONIC BOOK DEVICE AS TOUCH INPUT DEVICE AND DEVICE THEREOF

(76) Inventors: Chun JIANG, Taipei County (TW); Xujun Qiu, Shanghai City (CN); Tony Tsai, Taipei County (TW)

(21) Appl. No.: 12/868,258

(22) Filed: Aug. 25, 2010

(30) Foreign Application Priority Data
Aug. 25, 2009 (TW) 098128485

(51) Int. Cl. G06F 3/041

(52) U.S. Cl. 345/173

(57) ABSTRACT

A method of using an electronic book device as touch input device and an electronic book device for employing this method are provided. The method is applicable for a connection between an electronic book device and an electronic device. Based on an obtained control command, the electronic book device can activate a touch input mode by providing a touch input device parameter for the electronic device to identify the electronic book device as a touch input device. When the touch input mode is activated, the electronic book device can obtain a coordinate data corresponding to a touched position on a touch module thereof, and transmit the coordinate data to the electronic device for e.g. analysis and displaying a track corresponding to a plurality of the touched positions.

### CROSS-REFERENCE TO RELATED APPLICATION

This application claims the benefit of Taiwan Patent Application No. 098128485, filed on Aug. 25, 2009, which is hereby incorporated by reference for all purposes as if fully set forth herein.

### BACKGROUND OF THE INVENTION

1. Field of Invention

The present invention relates to a method by which an electronic book device can have touch input capability, and more particularly relates to a method in which an electronic book device is utilized as a touch input device for an electronic device connected to the electronic book device, and relates to an electronic book device for employing this method.

2. Related Art

Referring to FIG. 1, it shows a drawing of a conventional electronic book device. In the prior art, the electronic book device 1 is stored with media and data, such as images, texts or pictures to be watched. In addition, the electronic book device 1 is configured with a switch key 13 for turning pages, scrolling pages, and shifting data to be read.

To further improve convenience of the electronic book device 1, a touch module 11, such as a touch panel or a touch screen, is configured on the electronic book device 1. The touch module allows a user to use a finger or a touch pen 12 to touch to active a function option displayed on the screen of the electronic book device 1 or to perform scroll bar operations or data entry functions, for example touching to activate function options, converting tracks into texts, and plotting graphics or lines.

Moreover, the electronic book device 1 can be connected with an electronic device, such as a personal computer (PC), a personal digital assistant (PDA) or a digital handheld phone, to transmit data or update stored data. Further the electronic book device 1 can be connected with a display device such as a projector or a large display device, such that one may conduct a presentation through displaying the media data in the electronic book device 1.

However, when the electronic book device is connected with other electronic devices, only the data transmission and the data update can be performed. Moreover, the touch function of the electronic book device is not able to apply to control or input data to the connected electronic device but rather control the media data in the electronic book device and the presentation function. As a result, how to further expand the touch function of the electronic book device in the application to the connected electronic device is an issue to be considered by the vendors.

### SUMMARY OF THE INVENTION

Accordingly, the present invention is directed to a method of using an electronic book device as a touch input device, which is applicable for a connection between the electronic book device and an electronic device.

The method of using an electronic book device as a touch input device includes the following steps. First a control command is obtained to determine whether to activate a touch input mode of the electronic book device. If the determination is not to activate the touch input mode, a data transmission mode of the electronic book device is activated and a data transmission path between the electronic book device and the electronic device is set up for transmitting data. On the other hand, if the determination is to activate the touch input mode, the electronic book device will provide a touch input device parameter for the electronic device to identify the electronic book device as a touch input device used to input data into the electronic device. Then, the electronic book device can obtain a coordinate data corresponding to a touched position on a touch module of the electronic book device and transmit the coordinate data to the electronic device.

The present invention further discloses an electronic book device suitable for connecting to an electronic device. The electronic book device includes a touch module and a switch key. A touched position on the touch module corresponds to a coordinate data. The switch key is used for determining to activate a touch input mode or a data transmission mode of the electronic book device, and the switch key can be pressed to activate the data transmission mode or touch input mode. Pressing the switch key to activate the touch input mode makes the electronic book device provide a touch input device parameter for the electronic device to identify the electronic book device as a touch input device used to input data into the electronic device. And the touch input mode of the electronic book device enables transmitting the coordinate data to the electronic device.

An advantage of the present invention is that by the method of using an electronic book device as a touch input device, the electronic book device can be used as a data input device for an electronic device connected to the electronic book device, so that data input such as text data input and touch input such as input of tracks formed by touching the electronic book device can be performed. Therefore, a user doesn't have to purchase additional touch input devices such as a handwriting pad or a plotting board for the electronic device, thereby saving cost, reducing complexity of utilization of the electronic device, and providing a new application area for the touch input function of the electronic book device.

### BRIEF DESCRIPTION OF THE DRAWINGS

The present invention will become more fully understood from the detailed description given herein below for illustration only, and thus are not limitative of the present invention, and wherein:

FIG. 1 shows a drawing of a conventional electronic book device.

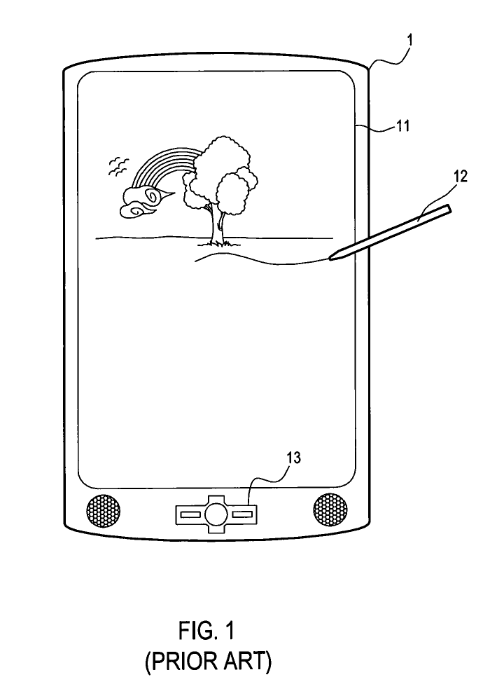

FIG. 2 shows a flowchart of a method of using an electronic book device as a touch input device according to one embodiment of the invention.

FIG. 3 shows a drawing of mode options available for selecting and displayed on an electronic book device according to one embodiment of the invention.

FIG. 4 shows a drawing of an electronic device which displays tracks input by touching the electronic book device according to one embodiment of the invention.

FIG. 5 shows a drawing of an electronic book device having a switch key configured according to embodiments of the invention.

### DETAILED DESCRIPTION OF THE INVENTION

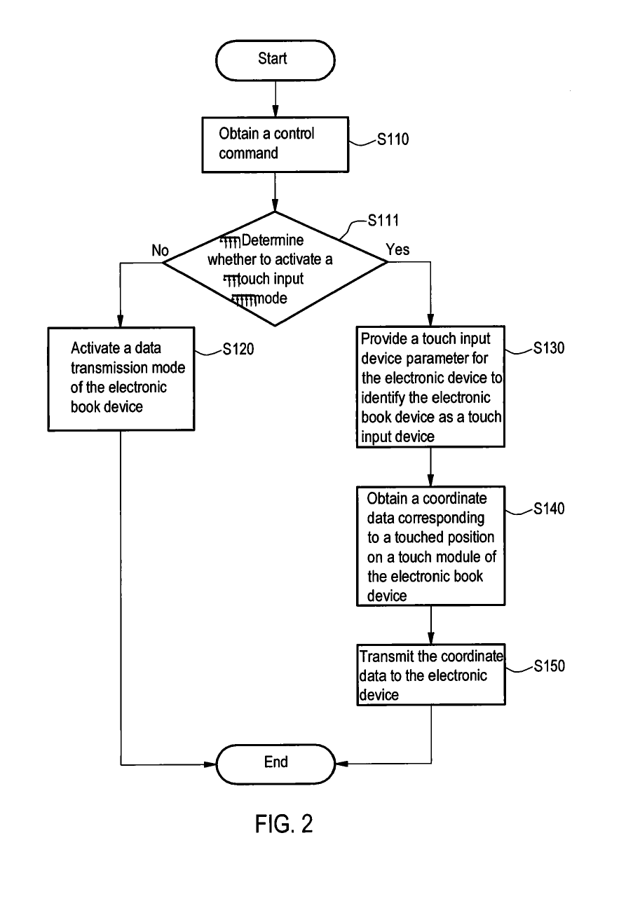

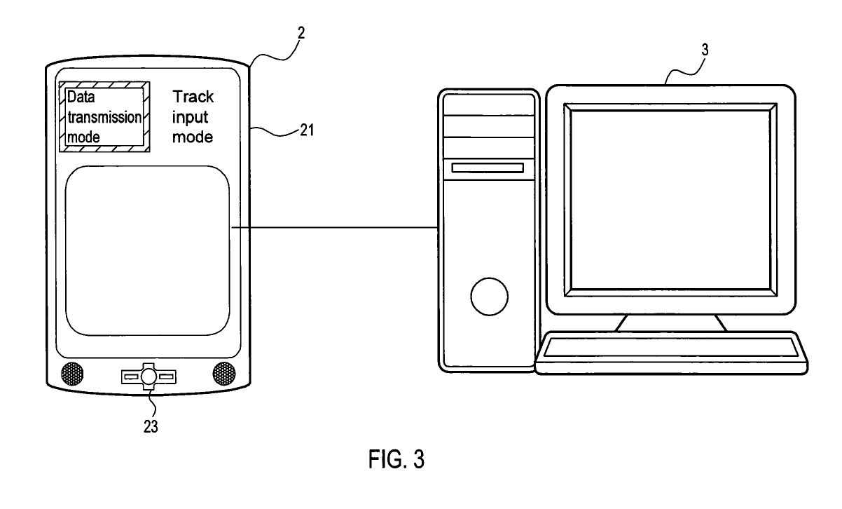

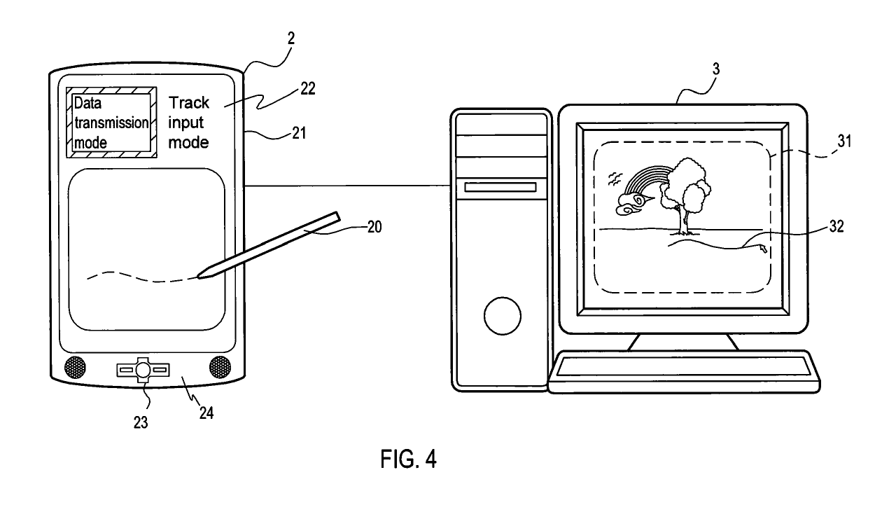

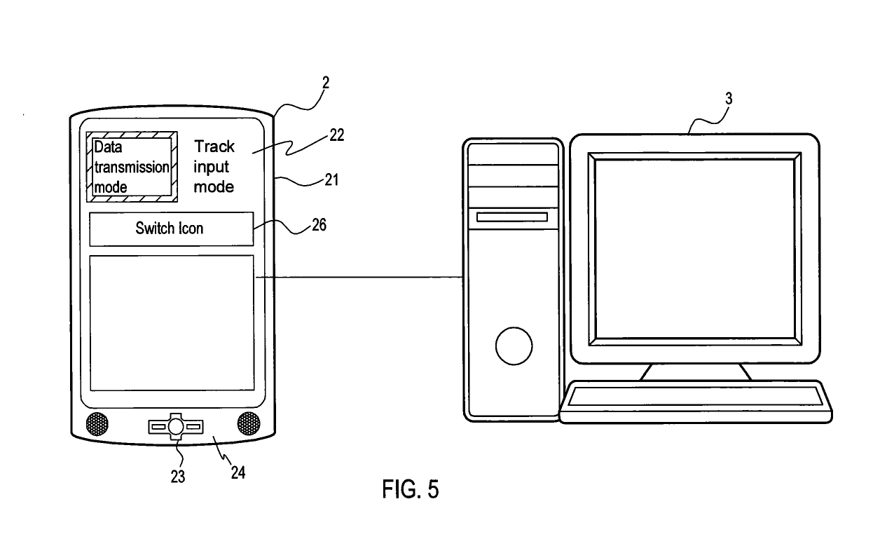

FIG. 2 shows a flowchart of a method of using an electronic book device as a touch input device according to one embodiment of the invention. FIG. 3 shows a drawing of mode options available for selecting and displayed on an electronic book device according to one embodiment of the invention. FIG. 4 shows a drawing of an electronic device which displays tracks input by touching the electronic book device according to one embodiment of the invention. And FIG. 5 shows a drawing of an electronic book device having a switch key configured according to embodiments of the invention. The method of using an electronic book device as a touch input device in the embodiments is applicable for a connection between an electronic book device and an electronic device as shown in FIG. 3. Herein an electronic device 3 such as a computer is taken only as an example of the electronic device and is not intended to limit the scope of the electronic device that can be used in the invention. The method of using an electronic book device 2 as a touch input device includes the following steps, explained with reference to FIGS. 2-5.

First a control command is obtained (step S110) to determine whether to activate a touch input mode of the electronic book device 2 (step S111). In an embodiment, as shown in FIG. 3, when the electronic book device 2 is connected to an electronic device 3 through a device such as a USB (Universal Serial Bus) device, a Mini USB device or an IEEE-1394 device, the electronic book device 2 displays a mode selection screen which includes mode options of data transmission mode and touch input mode, allowing a user to select one of the modes, with the selection acting as the control command.

There may be two approaches to obtaining the control command. In one approach, one may press a switch key which may be a switch button 23 disposed on a touch pad 24 of a touch module 21 in the electronic book device 2. In another approach, one may press a switch key which may be a switch icon 26 disposed on a touch screen 22 of the touch module 21 in the electronic book device 2, so as to activate the touch input mode or the data transmission mode of the electronic book device 2.

In short, the control command may be obtained by pressing a switch key to activate the touch input mode or the data transmission mode of the electronic book device 2. In one embodiment, the touch module 21 includes a touch screen 22 and the switch key is displayed on the touch screen 22. In another embodiment, the touch module 21 includes a touch pad 24 and the switch key is disposed on the touch pad 24. Otherwise, the switch key may be disposed on a surface of the electronic book device 2. Also It's noted that the word “key” in the term “switch key” is herein used as a generic word which also represents or encompasses the concepts of e.g. “button”, “switch”, and “icon”, and other things that can be used to initiate a function or produce a desired response.

If the control command is not to activate the touch input mode, the electronic book device 2 will activate the selected data transmission mode thereof and then the electronic book device 2 can transmit data transmission parameters to the electronic device 3. Upon receiving the data transmission parameters, the electronic device 3 would determine that the electronic book device 2 has been connected and a data transmission path between the electronic book device 2 and the electronic device 3 is then set up. Therefore, a data transmission operation can be performed between the electronic device 3 and the electronic book device 2 (step S120). As the technology of the data transmission operation of the electronic book device 2 is well known by a person having ordinary skill in the pertinent art or technical field, further description is not provided here.

On the other hand, if the control command is to activate the touch input mode, the electronic book device 2 can provide a touch input device parameter for the electronic device 3. Upon receiving the touch input device parameter, the electronic device 3 initializes a connection setting between the electronic device 3 and the electronic book device 2, so as to identify the connected electronic book device 2 as a touch input device (step S130), such as a hand writing pad or a plotting board, the touch input device being used to input data into the electronic device.

When the touch input mode is activated, one or more coordinate data corresponding to a touched position on the touch module 21 of the electronic book device 2 can be obtained (step S140). As shown in FIG. 4, when the touch pen 20, the user's finger or other tool is used to touch the touch module 21 of the electronic book device 2 so as to form a track, the electronic book device 2 can obtain or record the coordinate data corresponding to the touched positions on the touch module 21 and then transmit the recorded coordinate data to the electronic device 3 (step S150). Based on the size of the track display area 31 and configured display positions corresponding to the coordinate data, the electronic device 3 can display a track 32 on the track display area 31.

Furthermore, the electronic book device 2 is capable of switching between the touch input mode and the data transmission mode. After the step S120 is performed to enable data transmission operation between the electronic book device 2 and the electronic device 3, the electronic book device 2 may obtain a switch command to switch the electronic book device 2 from the data transmission mode to the touch input mode. On the other hand, after the step S150 is performed to accomplish a touch input operation between the electronic device 3 and the electronic book device 2, the electronic book device 2 may obtain a switch command to switch the electronic book device 2 from the touch input mode to the data transmission mode.

There are at least two approaches to issuing the switch command. As shown in FIG. 3, in one approach the active mode and the idle mode that can be switched into are displayed on the electronic book device 2, and when the touch pen 20 (or the tools or the user's finger) presses to activate the idle mode, the electronic book device 2 will turn off the active mode and turn on the idle mode (e.g., switching from the touch input mode to the data transmission mode or switching from the data transmission mode to the touch input mode).

In another approach, a switch key can be disposed on the touch module 21 of the electronic book device 2, so that the user can switch between the touch input mode and the data transmission mode by pressing the switch key. In one embodiment, as shown in FIG. 5, the touch module 21 of the electronic book device 2 includes a touch screen 22 and the switch key which may be a switch icon 26 is disposed on the touch screen 22. In another embodiment, the touch module 21 of the electronic book device 2 includes a touch pad 24 and the switch key which may be a switch button 23 is disposed on the touch pad 24, so that the user can press the switch key to switch between the touch input mode and the data transmission mode.

Alternatively, the switch key may be disposed on a surface of the electronic book device 2. Once the switch key is pressed, the electronic book device 2 will turn off the active mode and switch to a desired mode (e.g., switching from the touch input mode to the data transmission mode or switching from the data transmission mode to the touch input mode).

The present invention further discloses an electronic book device 2 suitable for connecting to an electronic device 3, wherein the electronic book device 2 includes a touch module 21 and a switch key. A touched position on the touch module 21 corresponds to a coordinate data. In one embodiment, the touch module 21 includes a touch screen 22 and the switch key is displayed on the touch screen 22. In another embodiment the touch module 21 includes a touch pad 24 and the switch key is disposed on the touch pad 24. The switch key may be a switch button 23 disposed on the touch pad 24 or a switch icon 26 disposed on the touch screen 22. Alternatively, the switch key may be disposed on a surface of the electronic book device.

The switch key is used for determining to activate a touch input mode or a data transmission mode of the electronic book device 2. Pressing the switch key to activate the touch input mode makes the electronic book device 2 provide a touch input device parameter for the electronic device 3 to identify the electronic book device 2 as a touch input device used to input data into the electronic device 3. And the touch input mode of the electronic book device 2 enables transmitting the coordinate data to the electronic device 3. Alternatively, pressing the switch key to activate the data transmission mode enables setting up a data transmission path between the electronic book device 2 and the electronic device 3.

In addition, the touch input mode of the electronic book device 2 can be activated when the electronic book device 2 accesses or runs a software program, which may be external to the electronic book device 2. When the electronic book device 2 is connected to an electronic device 3 and accesses the software program, the electronic book device 2 may enter the touch input mode and thus act as a touch input device used to input data into the electronic device 3.

Moreover, as shown in FIG. 4 and mentioned above, when tracks are formed on the touch module 21 of the electronic book device 2, the touch module 21 of the electronic book device 2 can record coordinate data corresponding to the touched positions on the touch module 21.

As the method of using the electronic book device 2 as a touch input device has already been described above, further description of this method used in the disclosed electronic book device of the invention is not provided again.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method of using an electronic book device as a touch input device, applicable for a connection between the electronic book device and an electronic device, and comprising steps of:
obtaining a control command to determine whether to activate a touch input mode of the electronic book device;
if the determination is to activate the touch input mode, the electronic book device providing a touch input device parameter for the electronic device to identify the electronic book device as a touch input device used to input data into the electronic device;
when the touch input mode is activated, obtaining a coordinate data corresponding to a touched position on a touch module of the electronic book device; and
transmitting the coordinate data to the electronic device.

2. The method of using an electronic book device as a touch input device according to claim 1, comprising a step of:
if the determination is not to activate the touch input mode, activating a data transmission mode of the electronic book device and setting up a data transmission path between the electronic book device and the electronic device.

3. The method of using an electronic book device as a touch input device according to claim 2, wherein after the step of setting up a data transmission path between the electronic book device and the electronic device, the method further comprises a step of:
obtaining a switch command to switch the electronic book device from the data transmission mode to the touch input mode.

4. The method of using an electronic book device as a touch input device according to claim 1, wherein after the step of transmitting the coordinate data to the electronic device, the method further comprises a step of:
obtaining a switch command to switch the electronic book device from the touch input mode to a data transmission mode.

5. The method of using an electronic book device as a touch input device according to claim 1, wherein the control command is obtained by pressing a switch key to activate the touch input mode or a data transmission mode of the electronic book device.

6. The method of using an electronic book device as a touch input device according to claim 5, wherein the touch module comprises a touch screen and the switch key is displayed on the touch screen.

7. The method of using an electronic book device as a touch input device according to claim 5, wherein the touch module comprises a touch pad and the switch key is disposed on the touch pad.

8. The method of using an electronic book device as a touch input device according to claim 5, wherein the switch key is disposed on a surface of the electronic book device.

9. An electronic book device suitable for connecting to an electronic device, including
a touch module, on which a touched position corresponds to a coordinate data; and
a switch key for determining to activate a touch input mode or a data transmission mode of the electronic book device, wherein pressing the switch key to activate the touch input mode makes the electronic book device provide a touch input device parameter for the electronic device to identify the electronic book device as a touch input device used to input data into the electronic device;
wherein the touch input mode of the electronic book device enables transmitting the coordinate data to the electronic device.

10. The electronic book device according to claim 9, wherein pressing the switch key to activate the data transmission mode enables setting up a data transmission path between the electronic book device and the electronic device

11. The electronic book device according to claim 9, wherein the touch input mode of the electronic book device is activated when the electronic book device accesses a software program.

12. The electronic book device according to claim 9, wherein the touch module comprises a touch screen and the switch key is displayed on the touch screen.

13. The electronic book device according to claim 9, wherein the touch module comprises a touch pad and the switch key is disposed on the touch pad.

14. The electronic book device according to claim 9, wherein the switch key is disposed on a surface of the electronic book device.
